(19) United States
(12) Patent Application Publication
(10) Pub. No.: US 2005/0027844 A1
(43) Pub. Date: Feb. 3, 2005

(54) Method and system for tracking and controlling a remote device

(76) Inventors: Ravi Hariprasad, Boston, MA (US); Rajesh Ghanta, Boston, MA (US); Praveen Ghanta, Hicksville, NY (US); Ravi Ghanta, Boston, MA (US)

Correspondence Address: ECKERT SEAMANS CHERIN & MELLOTT, 600 GRANT STREET, 44TH FLOOR, PITTSBURGH, PA, 15219, US

(21) Appl. No.: 10/728,249

(22) Filed: Dec. 4, 2003

Related U.S. Application Data
(63) Continuation of application No. 10/363,498, now abandoned.
(60) Provisional application No. 60/229,312, filed on Sep. 1, 2000.

(51) Int. Cl. G06F 15/173

(52) U.S. Cl. 709/223

(57) ABSTRACT

A method and apparatus for controlling remote computing devices such as portable computers (14) containing associated client components (10). The method includes a given client component (10) contacting a status server (22) containing client component status information; receiving client component status information from the status server (22) relayed in response to the client component (10) contacting the status server; evaluating the received status information to determine a status of the given client component (10), such as whether or not the component is stolen; in response to determining a particular status, contacting a command server (24) configured to send executable commands to the client component (10) in response to being contacted; receiving a command from the command server (24) instructing the client component (10) to perform a desired task, and in response to receiving said command, performing the desired task, such as transmitting location information or encrypting or deleting data.

### TECHNICAL FIELD

This invention relates to methods and systems for tracking and controlling remote devices, such as portable computers.

### BACKGROUND

The theft of electronic devices, such as personal computers, laptop computers and handheld computing devices, costs consumers and business billions of dollars every year. While the value of the stolen equipment itself is quite high, the cost of losing the personal and business data stored on an electronic dev ice can be even greater. What is needed is a system that is capable of tracking and aiding in the recovery of stolen devices.

### SUMMARY

The method and system of the present invention is used to track and control remote computing devices. It may be used to perform remote administration of a computing device and/or track its physical location. One potential use of the present system and method is to combat the growing problem of physical computing device theft. The method and system of the present invention may he used to deliver tracking information that may ultimately lead to recovery of a stolen computer and the apprehension of computer thieves. In addition, the ability to perform remote administration on the computing device will allow for the protection and retrieval of information stored on the computing device.

According to one aspect of the invention, a method of controlling remote computing devices containing associated client components is provided. The method includes a given client component contacting a status server containing client component status information; receiving client component status information from the status server relayed in response to the client component contacting the status server; evaluating the received status information to determine a status of the given client component; in response to determining a particular status, contacting a command server configured to send executable commands to the client component in response to being contacted; receiving a command from the command server instructing the client component to perform a desired task; and in response to receiving said command, performing the desired task.

In some embodiments, the desired task comprises sending location tracking information.

In some cases, the remote computing devices are laptop or handheld computers.

In some embodiments the status information indicates whether the remote computing device associated with the given client component is stolen.

In some embodiments, both the status server and command server are each configured for direct, independent communication with the client components.

In some cases, the status server is configured for communication with the client components through a common computer network, such as the Internet. The status server may be mirrored at webservers globally.

In some embodiments, the status information comprises a list of client components to contact the command server. In such cases evaluating the received status information includes determining whether the list includes the given client component. The list of client components may include those associated with devices reported as stolen, for example.

In some cases, the list of client components includes those requiring upgrade.

In some situations the desired task enables retrieval of information stored on the associated device, or includes encrypting or deleting data, for example.

In some embodiments, the client components are configured to contact the command server via a telephone system. The command server may include an incoming call telephone number identification system, for example. Contacting the command server may include searching to find a modem, and, upon identifying a modem, turning a modem speaker off and making a telephone call to a desired telephone number. Searching to find a modem can comprise sequentially writing a Hayes “ATZ” command to each COM port of the associated computing device and waiting for an “OK” response.

In some cases, the command server is configured to receive the telephone call and identify an incoming telephone number for tracking location of the computing device associated with the given client component.

According to another aspect of the invention, an apparatus for controlling remote computing devices containing associated client components includes a status server and a command server. The status server contains client component status information and is configured to be contacted by the client components and to, in response to being contacted by a given client component, send the client component status information to the given client component. The command server is configured to be directly contacted by a given client component in response to the client component receiving status information from the status server indicating that contact with the command server is necessary, and to send appropriate, executable commands to the client component in response to being contacted. Each client component is configured to initiate contact with the status server, receive client component status information from the status server relayed in response to the client component contacting the status server, evaluate the received status information to determine a status of the client component, initiate contact with the command server in response to determining a particular status, receive commands from the command server, and performing a desired task in response to the received commands.

Various embodiments of this aspect of the invention may have one or more of the features recited above.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 illustrates the basic function and relationship between a client component and a server component of a tracking system.

FIG. 2 illustrates the communication media by which the client and server are connected.

FIG. 3 illustrates one embodiment of a client-server interaction sequence performing functions of tracking and remote system administration.

FIG. 4 illustrates preferred functions for the client component to perform in order to be difficult to detect and remove.

FIG. 5 illustrates the functionality of the client loader.

FIG. 6 illustrates one possible architecture for the server.

FIG. 7 illustrates client—Status Webserver interaction.

FIGS. 8 and 9 illustrate one potential embodiment of a client and server telephone serial communication component.

Like reference symbols in the various drawings indicate like elements.

### DETAILED DESCRIPTION

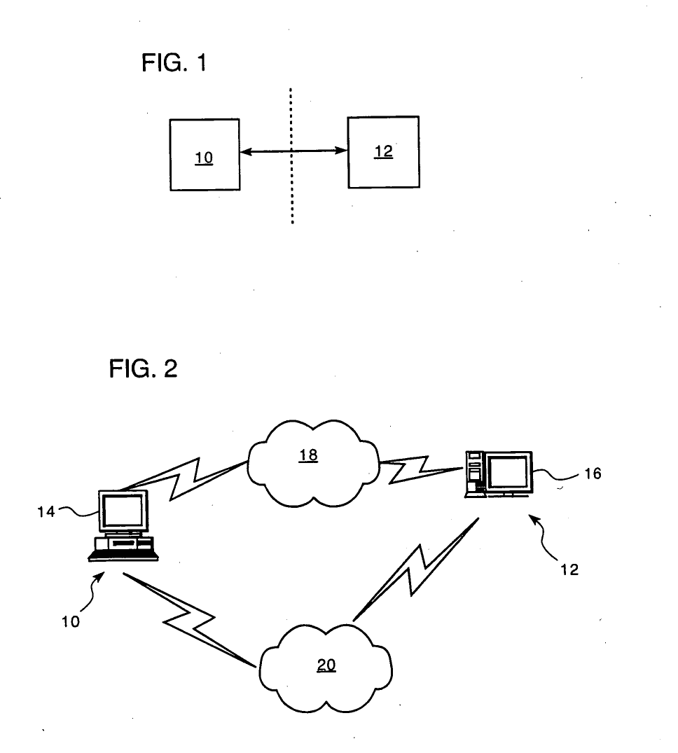

The present system is composed of two components: the client component 10 and the server component 12. Referring to FIGS. 1 and 2, the client component 10 is installed on the remote computing device 14, such as a laptop or handheld computer. The server component 12 is installed on a centrally located computer system 16. The server 16 is preferably connected to a computer network 18, such as the Internet, via a standard Transmission Control Protocol/Internet Protocol (TCP/IP) connection and to the telephone system 20 through either an analog phone line or a T-1/PRI interface. Alternatively, other configurations and communication protocols are known to those skilled in the art, and may be used. The client component 10 communicates with the server component 12, provides tracking information and executes control commands from the server component 12. The server component 12 communicates with the client component 10, stores location information in a database, and issues control commands to the client component 10.

As with any client-server system, there may be multiple clients interacting with a single server. Thus, the client component 10 may be installed on hundreds of computing devices 14, each of which interacts with a single server 16. Each client 14, however, contains a unique identification number, so that the server 16 can distinguish communication from each client. The server may consist of a single computer or several computers connected to a database. The database may be a Microsoft SQL Server or Oracle database, or any other known to one skilled in the art. The server may also be connected to a Hypertext Transfer Protocol (HTTP) interface, such that it can be controlled or viewed through the World-Wide Web (WWW).

FIG. 2 illustrates the communication media by which the client 14 and server 16 are connected. Communication may occur via the Internet 18 using TCP/IP or via the telephone network 20. In an alternative embodiment, the network 18 may be a private network, rather than the Internet. For instance, a corporation may use its Intranet to control and track remote computing devices 14 that are used by its employees.

Communication over the Internet 18, or other network, may utilize any standard communication protocol, such as Hypertext Transfer Protocol (HTTP), HTTP with Secure Sockets Layer communication (HTTPS), email, or File Transfer Protocol (FTP). Communication may also occur using custom communication with TCP or UDP packets. Communication over the telephone network 20 may occur using serial communication through a Computer modem. In the preferred embodiment, the Internet 18 or other network is used as the primary communication medium, with telephone communication 20 used only to provide additional tracking information.

Use of these two communication media allow for multiple methods of tracking. For instance, both the remote system's Internet Protocol (IP) address and the remote device's connected telephone number may be used to track the device 14. The IP address can be obtained by several techniques, described below. The telephone number may be obtained using AutoNumber Identification (ANI) or CallerID (services provided by most telephone companies) when the remote device 14 places a telephone call to the server 16. The IP address of the remote device 14 is maintained by an Internet Service Provider (ISP). The ISP responsible for an IP address can be ascertained from publicly available databases maintained by the United States government. With the date, time, and IP address, an ISP can provide User information to identify who was logged in at that time, allowing for apprehension of the thief and identifying the location of the remote system 14. By placing a telephone call, using the remote system's modem, the originating call number can be identified by the server 16, reverse looked up in public phone databases, again locating the location of the stolen machine. In the preferred embodiment, the technology of ANI is used, as it is more reliable than CallerID technology for identifying the originating phone number. Other methods are known to those skilled in the art, and may also be used.

In addition to tracking, the client-server communication may be used to perform a variety of remote administration functions. The server 12 can transmit a “control command” to the client 10, which will then execute that command locally. The actions to be performed by the client 10 when it receives a specific control command may be pre-programmed into the client. Examples of control commands include: “Dial”, “Upgrade”, “Uninstall”, “Delete File X”, “Encrypt File X”, “Upload File X”, etc. “Dial” instructs the client 10 to make a telephone call to the server 12, so that telephone number tracking may be obtained. “Upgrade” instructs the client 10 to download and install an updated version of itself. “Uninstall” instructs the client 10 to terminate operation and remove itself from the remote system 14. “Delete File X” instructs the client 10 to delete the file named “X” from the remote system 14. “Encrypt File X” instructs the client 10 to encrypt the file named “X” on the remote system 14. “Upload File X” instructs the client 10 to send file “X” to the server 12. Other commands may also be used, and are intended to be covered by the method and system of the present invention.

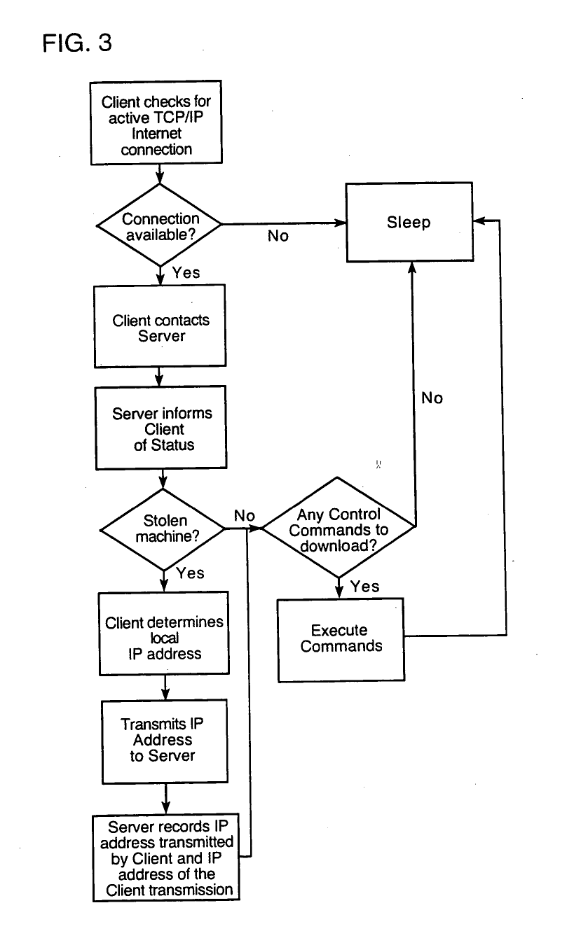

FIG. 3 illustrates one embodiment of a client-server interaction sequence performing the functions of tracking and remote system administration. In this embodiment, TCP/IP is used as the communication protocol, and the client and server communicate over the Internet, however other protocols and networks may be used.

The client checks for an active TCP/IP connection to the Internet. One way to do this is to “ping” the server and check for the appropriate response. If an active connection is not available, the client “sleeps” for a predefined period of time. While the client sleeps it also monitors for any TCP/IP events (such as a change in the local IP address). If any event is detected or the “sleep” period has expired, the client again checks for an active TCP/IP connection. If a connection is available, the server is contacted by the client. Communication between the client and server can occur via several different Internet protocols, as described above.

In the preferred embodiment, HTTP is used as the communication standard, as HTTP is the standard method of communicating over the Internet. By using HTTP, the server effectively functions as a “Webserver” connected to a database. Individual web pages may be developed to interact with the client to relay status and control commands, as well as log IP connections into a database.

The client transmits its unique identification number to the server. The server then determines the client's status and sends the status to the client. For instance, if the owner of the remote device has reported the device stolen, the database on the server will contain this information, and the status returned to the client is that it's current state is “stolen”.

The owner of the computer system can make reports by interacting with the server through a user interface, such as the WWW. Alternatively, the owner may telephone a central administration authority to make reports.

If the device is still in the owner's possession, administrative functions may be performed at this time by downloading and executing commands. As described above, these commands may include, without limitation, “Update”, “Uninstall”, “Dial”, “Upload”, “Encrypt”, “Decrypt”, and “Delete”.

If the current status of the client device is “stolen”, then the client will send information to the server in order for the server to determine its location for recovery. The client determines it's local IP address, preferably using functionality made available by the operating system. For example, on the MICROSOFT WIDOWS platform, the “WINSOCK” component may be used to do this. The client again contacts the server, transmitting the local IP address and the client unique ID. The server logs the transmitted IP address, the unique client ID, the time, date, and the IP address of the Internet communication. The transmitted IP address from the client may not necessarily match the IP address of the Internet communication. For example, in a Local Area Network where Internet access functions through a “proxy”, these two addresses will not match.

The server then sends the client a list of control commands to process. The client executes each of these commands. The commands may be executed linearly or in a multi-threaded manner.

The method and device described above allows for individuals or institutions to protect their computing devices and the information contained within them. In the event of a theft, they report their systems missing through the Web or another interface (such as a telephone interactive voice system, etc.). The next time the client installed on their system connects to the server, IP address tracking information may be obtained and recorded. Additionally, the system is instructed to contact the server through a telephone network, allowing telephone tracking information to be obtained and recorded. At the same time, other “control commands” that the customer would like his or her computer system to perform, may be executed. These commands allow for the safeguarding and retrieval of data.

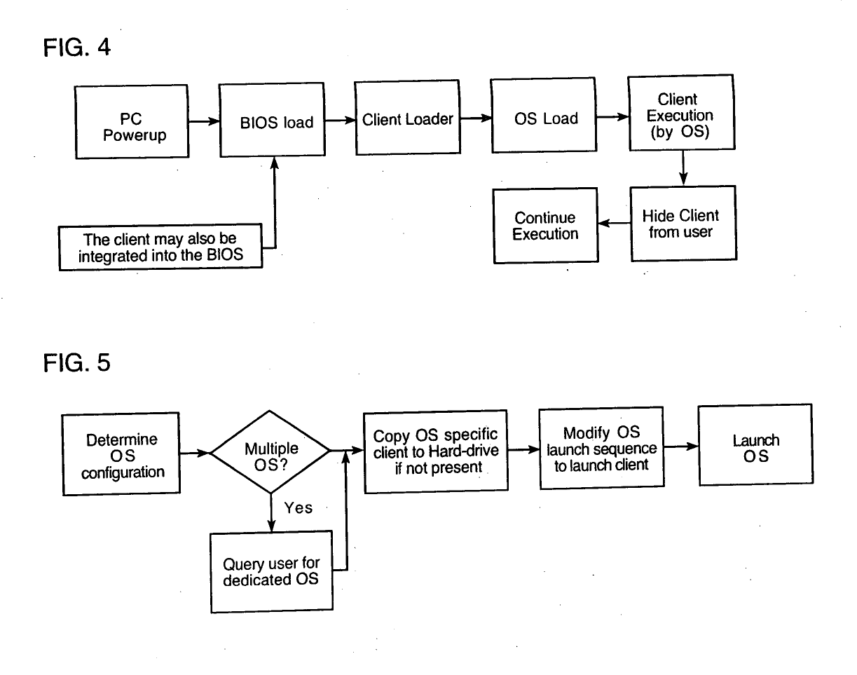

For the system to be most effective, the client component must be difficult to remove or detect. It should also be designed in a manner that ensures that it will remain active in the computer system's Random Access Memory (RAM). FIG. 4 illustrates the preferred functions for the client component to perform in order to be difficult to detect and remove.

As shown in FIG. 4, the computing device is powered up. The BIOS of the computing device is then loaded. As shown, in one embodiment, the BIOS manufacturer may integrate the client module into the BIOS of the computing device. In an alternative embodiment, the client is loaded by a “client loader”. The client loader is an application that acts as a traditional Operating System Loader. On boot-up the client loader is launched by the system BIOS.

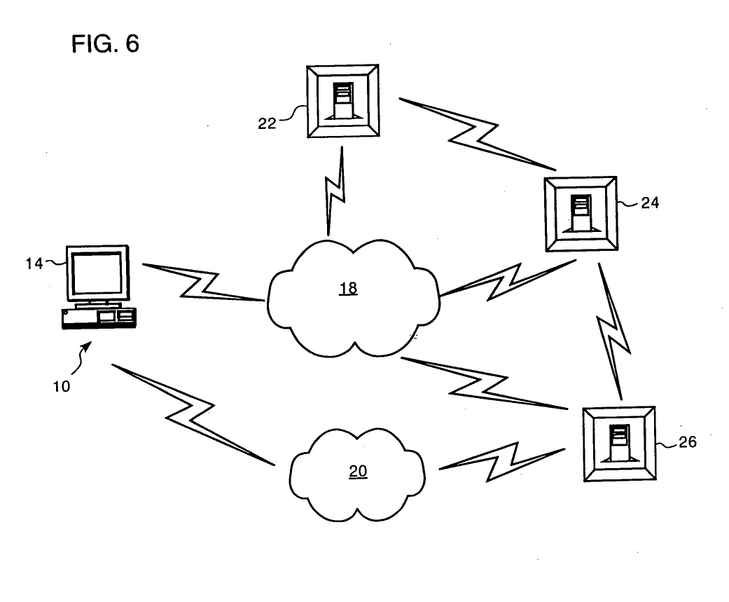

FIG. 5 illustrates the functionality of the client loader. The client loader first determines the Operating System (OS) present on the computer system. If multiple Operating Systems are present (e.g., MICROSOFT WINDOWS and LINUX), the user is queried as to which OS should be loaded. This is analogous to the functionality of traditional Operating System loaders. Depending on the OS that is loaded, the client loader then preferably copies the client module onto the appropriate hard drive partition that is specific to that OS. For example, if the OS is LINUX, a LINUX-specific version of the client module is copied to the hard drive LINUX partition. If the client is already present, this operation is skipped. The OS start or launch sequence is modified such that the client is launched by the operating system. For example, in a MICROSOFT WINDOWS 95/98 OS environment, the “Autoexec.bat” file may be modified, or the WINDOWS “Run” registry key entry. The OS will then execute the client in the startup sequence, as it would with other software installed on the machine. The client then hides itself from the user. This process is specific to the OS being used. For the WINDOWS operating system, there are a variety of widely available public domain techniques to hide an application from the typical user. For example, it may remove itself as an active program from the “WINDOWS Process List” or mask the process as a different program, such as a WINDOWS system “.dll” or “.exe”.

FIG. 6 illustrates one possible architecture for the server 16, although other architectures will be known to those skilled in the art and may alternatively be used. In FIG. 6, three computer systems are employed to carry out the processing. In principle, the functions of each of these systems can be defined and only one system needs to be used. Conceptually, the three systems perform three distinct tasks. The Status Webserver 22 functions to relay status information to the client module 10 and act as a gatekeeper to the Server. The Command Server 24 performs the functions of the server component described above. The ANI Identification System 26 performs telephone tracking.

There are several advantages to using three separate systems, particularly in separating the Status Webserver 22 from the Command Server 24. If there are millions of computer systems 14 with the client module 10 installed on them, there is the possibility that these clients can overwhelm the Server 24. The high load of client connections may tax the capabilities of the machine and the database. Thus, expensive hardware must be configured to handle the high volume of database interactions. In principle, this is unnecessary since a vast majority of the clients 14 will not be stolen and therefore will not require connection with the Server. By using an intermediary Status Webserver 22, the client is instructed to contact the Command Server 24 only if necessary.

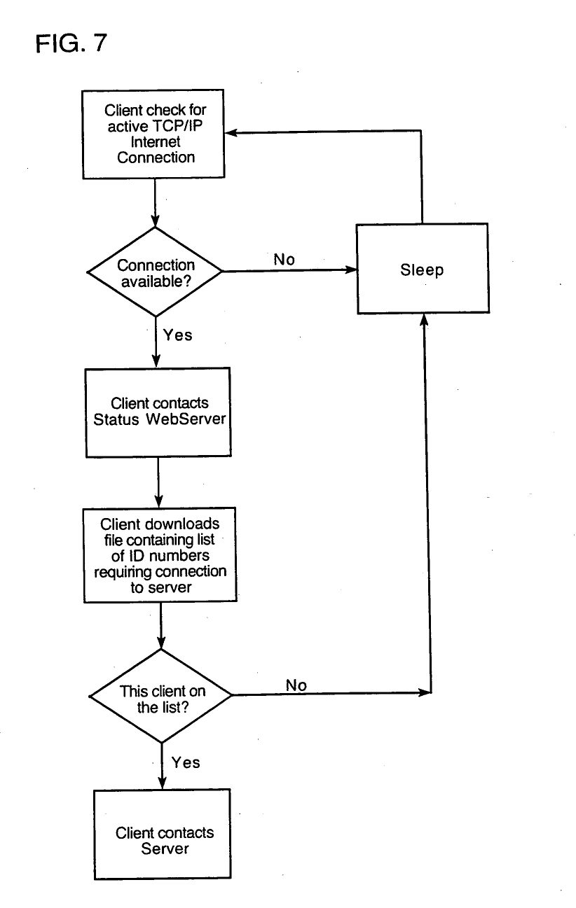

The function of the Status Webserver 22 is to inform the client 10 of its status. The Status Webserver stores a list of client identification numbers that must contact the Command Server 24. In general, these are the computing devices 14 that have been reported as stolen. FIG. 7 illustrates the client 10—Status Webserver 22 interaction. The Status Webserver 22 may be mirrored at webservers globally, further increasing scalability.

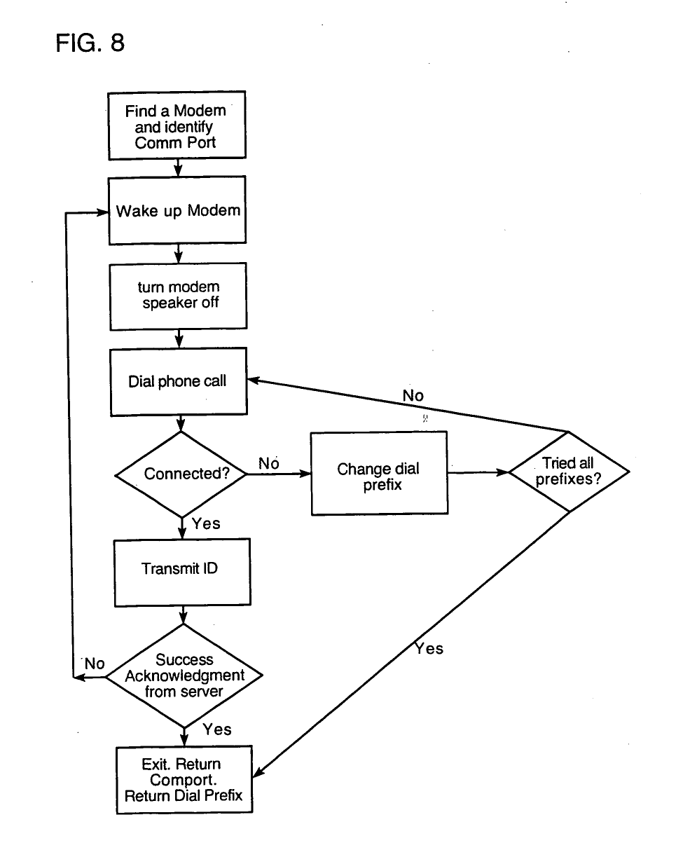

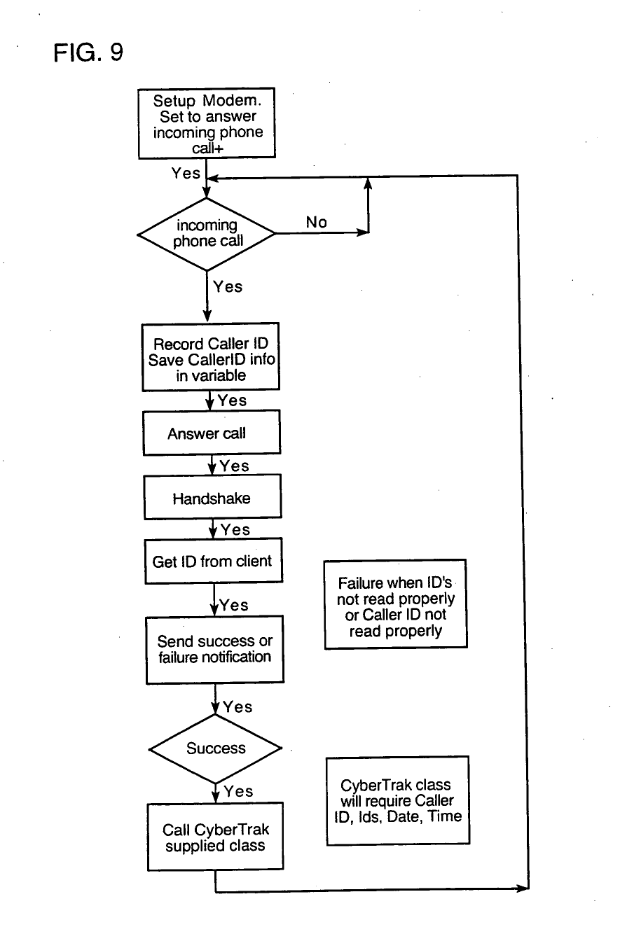

FIGS. 8 and 9 illustrate one potential embodiment of a client and server telephone serial communication component. In this case, the client 10 searches to find a modem on the remote PC system 14. There are a number of techniques to do this. One potential technique is to sequentially write the Hayes “ATZ” command to each COM port on the computer and await for an “OK” response. If such a response is received, the modem is identified. Once the modem is identified, the modem speaker is turned off and a telephone call to a predefined telephone number is made. The server answers the incoming call, and identifies the incoming call telephone number, through either CallerID or ANI. A serial communication link between the client and server is established and the client identification number is transmitted. The server logs the client identification number, telephone number, time, and date into a database.

A number of embodiments of the invention have been described. Nevertheless, it will be understood that various modifications may be made without departing from the spirit and scope of the invention. Accordingly, other embodiments are within the scope of the following claims.

1. A method of controlling remote computing devices (14) containing associated client components (10), the method comprising a given client component (10)
contacting a status server (22) containing client component status information;
receiving client component status information from the status server (22) relayed in response to the client component (10) contacting the status server;
evaluating the received status information to determine a status of the given client component (10);
in response to determining a particular status, contacting a command server (24) configured to send executable commands to the client component (10) in response to being contacted;
receiving a command from the command server (24) instructing the client component (10) to perform a desired task; and
in response to receiving said command, performing the desired task.

2. The method of claim 1 wherein the desired task comprises sending location tracking information.

3. The method of claim 1 wherein the remote computing devices (14) are laptop or handheld computers.

4. The method of claim 1 wherein said status information indicates whether the remote computing device (14) associated with the given client component (10) is stolen.

5. The method of claim 1 wherein both the status server (22) and command server (24) are each configured for direct, independent communication with the client components (10).

6. The method of claim 1 wherein the status server (22) is configured for communication with the client components (10) through a common computer network (18).

7. The method of claim 6 wherein the computer network (18) is the Internet.

8. The method of claim 7 wherein the status server (22) is mirrored at webservers globally.

9. The method of claim 1 wherein the status information comprises a list of client components (10) to contact the command server (24), and wherein evaluating the received status information comprises determining whether the list includes the given client component.

10. The method of claim 9 wherein the list of client components (10) includes those associated with devices (14) reported as stolen.

11. The method of claim 9 wherein the list of client components (10) includes those requiring upgrade.

12. The method of claim 1 wherein the desired task enables retrieval of information stored on the associated device (14).

13. The method of claim 1 wherein the desired task comprises encrypting data.

14. The method of claim 1 wherein the desired task comprises deleting data.

15. The method of claim 1 wherein the client components (10) are configured to contact the command server (24) via a telephone system (20).

16. The method of claim 15 wherein the command server (24) includes an incoming call telephone number identification system (26).

17. The method of claim 15 wherein contacting the command server (24) comprises
searching to find a modem; and
upon identifying a modem, turning a modem speaker off and making a telephone call to a desired telephone number.

18. The method of claim 17 wherein searching to find a modem comprises sequentially writing a Hayes “ATZ” command to each COM port of the associated computing device and waiting for an “OK” response.

19. The method of claim 15 wherein the command server (24) is configured to receive the telephone call and identify an incoming telephone number for tracking location of the computing device (14) associated with the given client component (10).

20. An apparatus for controlling remote computing devices (14) containing associated client components (10), the apparatus comprising
a status server (22) containing client component status information and configured to be contacted by the client components (10) and, in response to being contacted by a given client component (10), send said client component status information to said given client component; and
a command server (24) configured to be directly contacted by a given client component in response to said client component receiving status information from the status server (22) indicating that contact with the command server (24) is necessary, and to send appropriate, executable commands to said client component (10) in response to being contacted;
each client component (10) being configured to initiate contact with the status server, receive client component status information from the status server (22) relayed in response to the client component (10) contacting the status server, evaluate the received status information to determine a status of the client component (10), initiate contact with the command server (24) in response to determining a particular status, receive the commands from the command server (24), and perform a desired task in response to the received commands.

21. The apparatus of claim 20 wherein the desired task comprises sending location tracking information.

22. The apparatus of claim 20 wherein the remote computing devices (14) are laptop or handheld computers.

23. The apparatus of claim 20 wherein said status information indicates whether the remote computing device (14) associated with the given client component (10) is stolen.

24. The apparatus of claim 20 wherein both the status server (22) and command server (24) are each configured for direct, independent communication with the client components (10).

25. The apparatus of claim 20 wherein the status server (22) is configured for communication with the client components (10) through a common computer network (18).

26. The apparatus of claim 25 wherein the computer network (18) is the Internet.

27. The apparatus of claim 26 wherein the status server (22) is mirrored at webservers globally.

28. The apparatus of claim 20 wherein the status information comprises a list of client components (10) to contact the command server (24), and wherein evaluating the received status information comprises determining whether the list includes the given client component.

29. The apparatus of claim 28 wherein the list of client components (10) includes those associated with devices (14) reported as stolen.

30. The apparatus of claim 28 wherein the list of client components (10) includes those requiring upgrade.

31. The apparatus of claim 20 wherein the desired task enables retrieval of information stored on the associated device (14).

32. The apparatus of claim 20 wherein the desired task comprises encrypting data.

33. The apparatus of claim 20 wherein the desired task comprises deleting data.

34. The apparatus of claim 20 wherein the client components (10) are configured to contact the command server (24) via a telephone system (20).

35. The apparatus of claim 34 wherein the command server (24) includes an incoming call telephone number identification system (26).

36. The apparatus of claim 34 wherein contacting the command server (24) comprises
searching to find a modem; and
upon identifying a modem, turning a modem speaker off and making a telephone call to a desired telephone number.

37. The apparatus of claim 36 wherein searching to find a modem comprises sequentially writing a Hayes “ATZ” command to each COM port of the associated computing device and waiting for an “OK” response.

38. The apparatus of claim 34 wherein the command server (24) is configured to receive the telephone call and identify an incoming telephone number for tracking location of the computing device (14) associated with the given client component (10).
